(19) United States
(12) Patent Application Publication
(10) Pub. No.: US 2014/0306532 A1
(43) Pub. Date: Oct. 16, 2014

(54) Linear Alternator

(71) Applicant: Richard Lloyd Gray, Elk Grove, CA (US)

(72) Inventor: Richard Lloyd Gray, Elk Grove, CA (US)

(21) Appl. No.: 13/864,037

(22) Filed: Apr. 16, 2013

(51) Int. Cl. H02K 7/075; H02J 7/34; H02K 35/02

(52) U.S. Cl. CPC H02K 7/075; H02K 35/02; H02J 7/34
USPC 307/47; 310/24

(57) ABSTRACT

A linear alternator to supply the electrical utility needs of homes and small businesses comprises a radial arrangement of five cylinders around a common crankshaft. Mechanical input power is applied to the crankshaft for conversion to electrical output power. Each of the five radial cylinders is in itself a single linear alternator in which four sets of equally spaced shuttle magnets are arranged head-to-toe and separated by spacers and insulators. The shuttle magnets are mounted as an assembly on a rod independently driven by the crankshaft such that each of five rods can correspondingly move back and forth inside four matching sets of equally spaced pickup coils. Alternating currents from each of the twenty total pickup coils are individually rectified, filtered, and regulated to charge banks of batteries or ultra-capacitors. Solid-state inverters can be connected to the batteries or ultra-capacitors to produce utility grade AC power, or DC power outputs can be tapped directly.

### CO-PENDING APPLICATION

This Application claims benefit of U.S. Provisional Patent Application Ser. No. 61/625,588, filed Apr. 17, 2012, titled LINEAR ALTERNATOR, by Richard Lloyd Gray.

### BACKGROUND OF THE INVENTION

1. Field of the Invention

The present invention generally relates to electrical generators and alternators, and more specifically to single linear and five-point radial arrangements of reciprocating electrical generators for powering homes and small businesses.

2. Description of the Prior Art

The most familiar electrical generators to the public are belt-driven direct current (DC) generators and alternators used in automobiles to charge 12-volt DC batteries. Both designs use belts and pulleys to spin an armature inside a cylindrical stator shell. Alternators are high output generators that produce alternating current (AC) that must be rectified before the power output can be used to charge a battery or power a car. Most cars switched from using generators to alternators in the 1960's because alternators can produce substantial charging currents even at engine idle speeds.

Moving a winding through a magnetic field will cause an electrical current to be induced into the winding. The voltage, polarity, and current induced in the windings depends on how fast the winding is moved through the magnetic field, the strength of the magnetic field, the relative direction of movement, and the number of turns in the winding. Permanent magnets can be used to establish such magnetic fields, but in automobile generators and alternators a secondary electro-magnetic winding is supplied with a battery current to establish the necessary magnetic field in either the armature or stator. The electrical current induced in the other winding more than makes up for the cost in the current drain in the electro-magnetic winding.

Magnets or electro-magnets on shafts can also be reciprocated in and out, or through annular stator windings to generator electricity. The polarity of the electrical currents induced depends on the N-S orientation of the magnets and the relative direction of movement of the magnets through the stator windings. The magnitudes of the voltages and currents induced depends on the strength of the magnetic field at the stator winding, the degree of coupling achieved, and the speed of relative movement. In a reciprocating electrical generator, the reciprocating shaft carrying the magnets will oscillate from zero relative velocity, to maximum plus, to zero, to maximum minus, and back to zero in each cycle. A typical alternating current sinewave will appear in the stator windings.

A simple type of linear alternator is used in a “Faraday Flashlight”. A coil and a permanent magnet are arranged such that when the flashlight is shaken back and forth an electric current is induced into the coil by the movement of the magnetic fields of the magnet shuttling through it. The current produced is rectified and used to charge a battery-like, but long-life ultra-capacitor. The charge produced by half a minute of vigorous shaking is enough to power a light-emitting diode (LED) for a several minutes.

Reciprocating electric generators have found useful applications that convert the power of sea waves or tidal action to charge batteries, e.g., as used in navigation buoys, and in larger installations to power coastal communities. A prior art example is described in U.S. Pat. No. 7,498,685, issued to Timothy Turner on Mar. 3, 2009, and titled Electrical Generator. A much smaller application for wireless tire pressure sensors is described in U.S. Pat. No. 7,009,310, issued to Jeffrey Cheung, et al., on Mar. 7, 2006, and titled Autonomous Power Source.

Ronald Goldner, et al., describe an Electromagnetic Linear Generator and Shock Absorber, in U.S. Pat. No. 6,952,060, issued Oct. 4, 2005. Such describes a super-positioning of radial components and adjacent magnets to produce a maximum average radial magnetic flux density within a coil winding array. Such a vector superposition of the magnetic fields and magnetic flux from a plurality of magnets is claimed to cause “a nearly four-fold increase in magnetic flux density . . . over conventional electromagnetic generator designs with a potential sixteen-fold increase in power generating capacity.” In a regenerative shock absorber embodiment, parasitic displacement motions and vibrations in cars encountered under normal urban driving conditions are converted to useful electrical energy for powering vehicles and accessories, or charging the vehicles' batteries.

What is needed is an electrical power generating system that can be scaled up and relied on to power typical home and small business utility applications.

### SUMMARY OF THE INVENTION

Briefly, a linear alternator embodiment of the present invention to supply the electrical utility needs of homes and small businesses comprises a radial arrangement of five cylinders around a common crankshaft. Mechanical input power from a motor, engine, or turbine is applied to the crankshaft for conversion to electrical output power. Each of the five radial cylinders is in itself a single linear alternator in which four sets of equally spaced shuttle magnets are arranged head-to-toe and separated by spacers and insulators. The shuttle magnets are mounted as an assembly on a rod independently driven by the crankshaft such that each of five rods in different phases can correspondingly move back and forth inside four matching sets of equally spaced pickup coils. Alternating currents from each of the twenty total pickup coils are individually rectified, filtered, and regulated to charge banks of batteries or ultra-capacitors. Solid-state inverters can be connected to the batteries or ultra-capacitors to produce utility grade AC power, or DC power outputs can be tapped directly.

These and other objects and advantages of the present invention will no doubt become obvious to those of ordinary skill in the art after having read the following detailed description of the preferred embodiments that are illustrated in the various drawing figures.

### IN THE DRAWINGS

FIGS. 1A-1D are functional block, schematic, and perspective view diagrams of a proof-of-concept demonstrator embodiment of the present invention for electrical power generation. FIG. 1A represents the reciprocating shaft at 0-degrees of crankshaft rotation. FIG. 1B represents a clear view of the reciprocating shaft without the pickup windings. FIG. 1C represents a perspective view detail of one set of magnets mounted on the reciprocating shaft. FIG. 1D represents the reciprocating shaft at 180-degrees of crankshaft rotation;

FIG. 2 is an end view diagram of a five-point radial linear alternator in an embodiment of the present invention for electrical power generation from a mechanical power input to a crankshaft;

FIGS. 3A and 3B are graphs representing the electrical phases of the AC voltages respectively induced in the five banks of pickup coil windings in each branch of the five-point radial linear alternator of FIG. 2, and of the DC voltage summations that occur at the outputs of the full-wave bridge rectifiers; and

FIG. 4 is a schematic diagram of a utility power generator like those described in FIGS. 1A-1D, 2, 3A, and 3B.

### DETAILED DESCRIPTION OF THE PREFERRED EMBODIMENTS

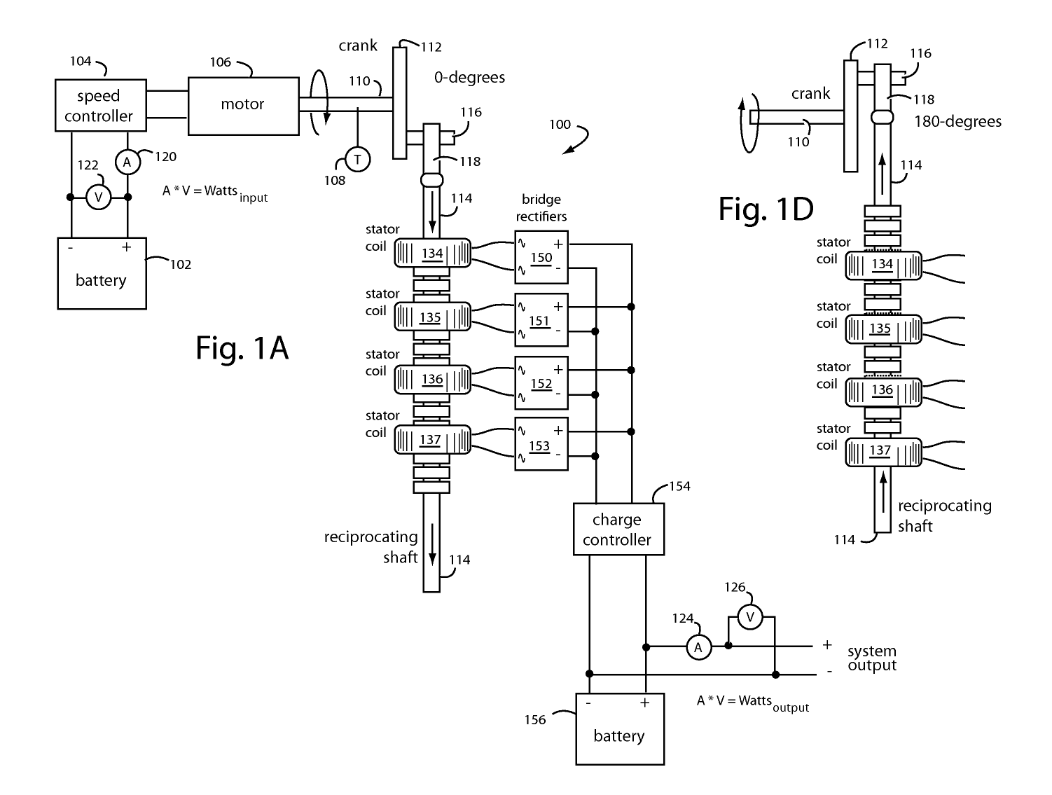

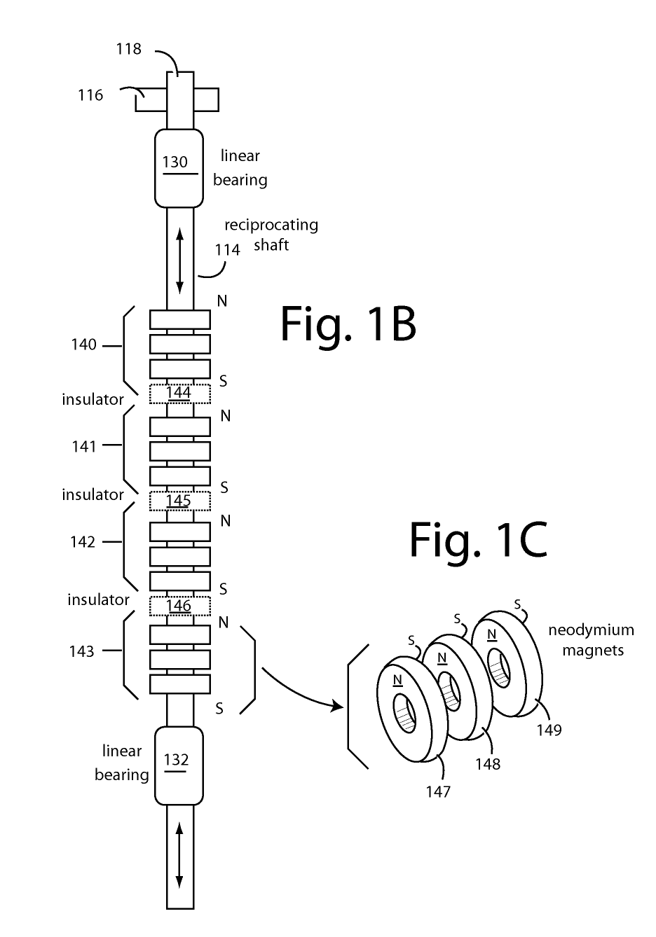

FIGS. 1A-1D represent a reciprocating electrical generator 100 in a proof-of-concept demonstrator embodiment of the present invention. This was a prototype that was constructed to be displayed and operated on a large table top. A motor battery 102 provided operating power through a motor speed controller 104 to an electrical motor 106. The motor speed controller 104 was programmable, and was adjusted to maintain a constant speed in motor 106 under varying load conditions. The rotational speed was displayed to observers by a mechanical tachometer (T) 108 attached to a rotating shaft 110. A nominal operating speed was set 1,000 RPM. A crank 112 was coupled to a reciprocating shaft 114 by a pin 116 and a connecting link 118.

The amount of power being input to electrical generator 100 at any instant could be estimated by observers from an ammeter (A) 120 and a voltmeter (V) 122. Power in watts (W) is the product of current in amps times the voltage in volts. W=A*V. The amount of power being output by electrical generator 100 could also be determined by observers at the same instant from an ammeter (A) 124 and a voltmeter (V) 126. A particular prototype of the reciprocating electrical generator 100 was configured to produce a direct current (DC), 12-volt system output. The speed of motor 106 was adjusted by speed controller 104 to optimize such 12-volt system output.

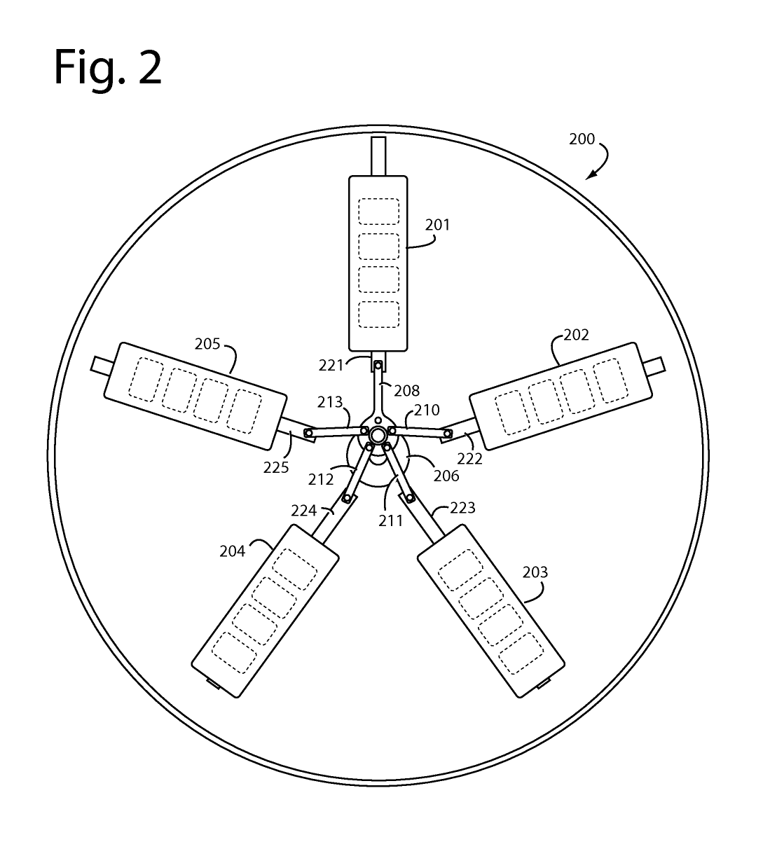

In general, embodiments of an electrical generator have at least one hollow aluminum cylinder (shown in FIG. 2) fitted with linear bearings 130 and 132 at each end. Each of linear bearings 130 and 132 preferably comprise polyoxymethylene (POM), better known by the DuPont trademark, DELRIN. The resulting plastic on polished 316-stainless bearing interface provides for very low friction operation of the reciprocating shaft 114.

Four stator coils 134-137 were configured as annular-ring pickup windings mounted in tandem and coaxially disposed, supported, and fixed within the aluminum cylinder. Each stator coil 134-137 is periodically arranged, collinear, and parallel to one another, e.g., equal distances apart with a uniform pitch and interspacing. Reciprocating shaft 114 is coaxially disposed through the centers of each and all of the stator coil 134-137. Reciprocating shaft 114 is coaxially supported at opposite ends by the linear bearings 130 and 132.

As best seen in FIGS. 1B-1C, the single reciprocating shaft 114 was fitted with four sets 140-143 of equally spaced neodymium permanent magnets arranged head-to-toe, north (N) to south (S), and separated by spacers and insulators 144-146. The optimum amount of spacing and separation was empirically determined. Each set of magnets 140-143 was itself an assembly of three constituent puck-shaped magnets 147-149. Other constituencies, arrangements and organization schemes are also possible. For example, larger annular magnets specially constructed for this purpose.

The neodymium permanent magnet groups 140-143 were threaded through their centers and mounted in collinear arrangement in totem-pole fashion on a middle length of the reciprocating shaft 114. The periodicity, or separation between of each group of neodymium permanent magnets matches those of the four annular-ring pickup coils 134-137. This is such that the stroke of the reciprocating shaft carries each group of magnets in and through, and back out of its corresponding annular-ring pickup coil equally on both opposite sides and all in tandem.

The four annular-ring pickup coils 134-137 were all individually connected to independent full-wave rectifier bridges 150-153. These were summed together at their plus (+) and minus (−) terminals for connection to a charge controller 154. Such charger controller 154 included large capacitors for filtering, and both voltage and current regulators to maintain a charge on an output battery 156.

The independent, four-branch parallel configuration of the full-wave rectifier bridges 150-153 permits wide tolerances in the relationships, spacing, phasing, and polarity amongst the assembled annular-ring pickup coils 134-137 and the neodymium permanent magnet sets 140-143 moving inside them. Each of the four branches will contribute an equal share of the work output by virtue of the automatic switching occurring in the rectifiers.

FIG. 2 represents a five-radial, linear-alternator embodiment of the present invention for supplying the electrical utility needs of homes and small businesses. Such is referred to herein by the general reference numeral 200, and comprises an equal 72-degree radial arrangement of five cylinders 201-205 around a common crankshaft 206. Each of the five radial cylinders 201-205 is in itself a single linear alternator with four pickup winding coils housed in a hollow aluminum tube with closed ends and linear bearings, similar to the reciprocating electrical generator 100 described in FIGS. 1A-1D.

A master connecting rod 208 and four connecting links 210-214 are conventionally attached with wrist pins to reciprocating shafts 221-225. If common crankshaft 206 is rotated clockwise, as seen in FIG. 2, reciprocating shaft 221 will be at its top dead center (TDC=0-degrees) of its stroke, reciprocating shaft 222 will be approaching its TDC, reciprocating shaft 223 will just be leaving its bottom dead center (BDC=180-degrees), and reciprocating shaft 224 is almost at its BDC. Reciprocating shaft 225 is fast approaching its TDC.

What is important to see in FIG. 2 is the five reciprocating shafts 221-225 are in very different phases of their respective travel. Since all five cylinders 201-205 are equipped with pickup coils that output AC electrical power due to the movement of the magnets on the reciprocating shafts 221-225, the AC voltage phases will be similarly distributed at any one instant in time in five places respective to each 360-degree rotation cycle of crankshaft 206.

Experiments and calculations regarding the use of an even number of linear alternator cylinders indicate the performance suffers compared to the five shown in FIG. 2. Three or seven cylinders may be better than two, four, six, or eight, but five seems to be optimum in this application.

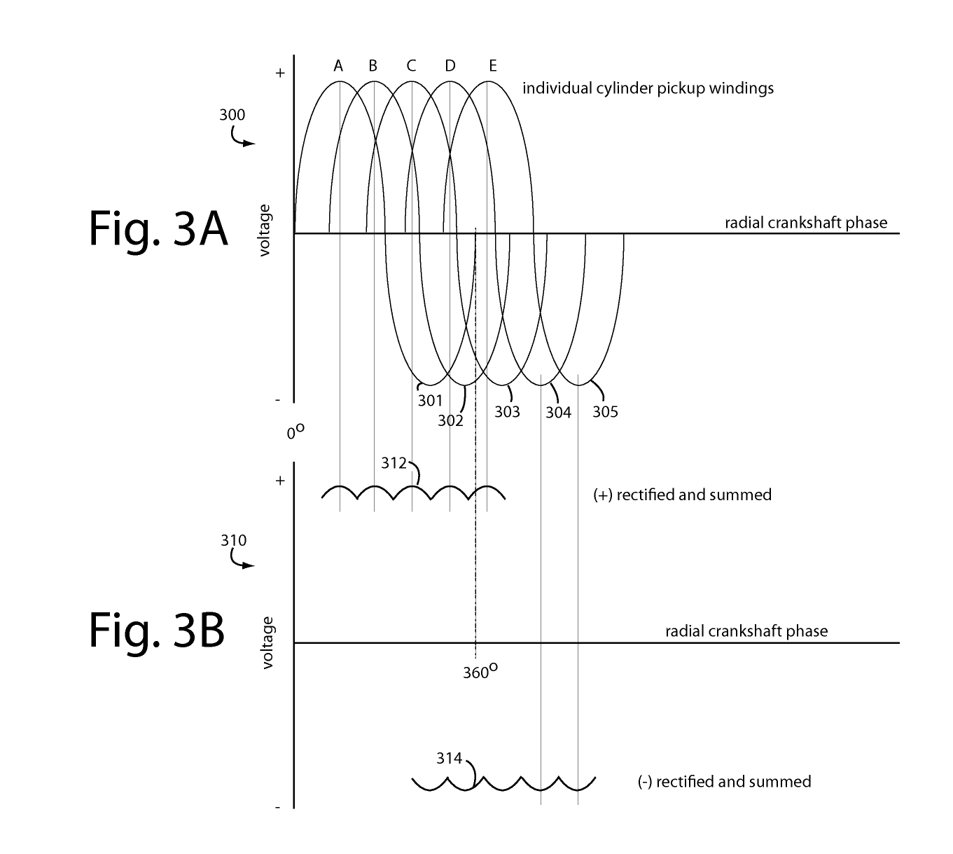

FIGS. 3A-3B are intended to illustrate the beneficial consequences of the AC power output distribution that occurs with the use of the five linear alternator cylinders 201-205 in the radial arrangement Of FIG. 2. A graph 300 in FIG. 3A shows the voltage phase relationships 301-305 (A-E) of the pickup coil outputs of the five linear alternators 201-205 in FIG. 2. Each is separated from the others by 72-degrees of crankshaft rotation. Summing of the output voltages occurs after rectification, and the summations of voltage phase relationships 301-305 after positive and negative rectification are represented in a graph 310 by ripple waveforms 312 and 314.

It can be deduced therefore from FIGS. 3A and 3B that each pickup coil bank in only one of the five branches is carrying the full electrical output load at a time, but only for a small fraction of the rotation of the crankshaft for each cycle. For example, less than 36-degrees of crankshaft rotation. The mechanical input loading that presents itself as pulses, is therefore smoothed out into at least ten pulses per rotation cycle. A simple, single linear alternator presents two pulses of loading resistance to mechanical input, one positive and one negative that peak when the velocity of the magnet is maximum inside the pickup coil and the pickup coil has an electrical load on it that will cause a counter-EMF to be applied back to the magnet as a form of inertia.

It can also be seen that the amount of ripple filtering needed at the output of the full-wave bridge rectifiers (e.g., 150-151) will be quite modest because all twenty full-wave bridge rectifiers (for the example of FIG. 2) are all summed together and their five negative and five positive voltage peaks, ten altogether in each full rotation, automatically interleave and dovetail with one another.

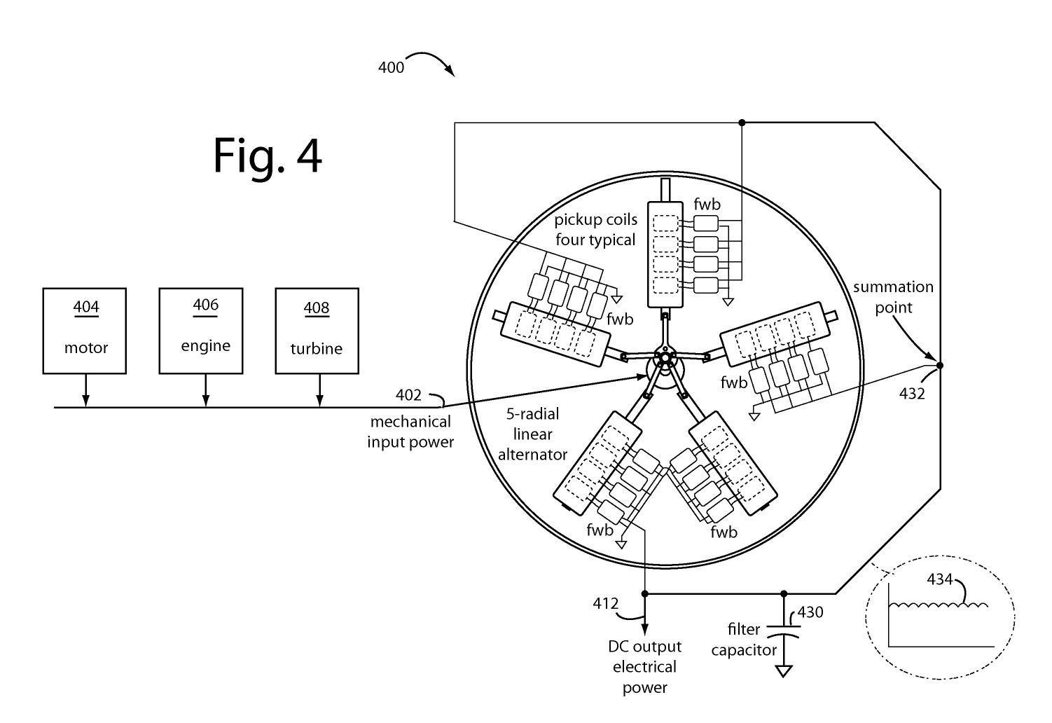

FIG. 4 shows how mechanical input power 402 from a motor 404, engine 406, or turbine 408 is configured for application to crankshaft 410 (e.g., crankshaft 206 in FIG. 2) for conversion to electrical output power 412 by a 5-radial linear alternator 414. Each of the five radial cylinders 416-420 is in itself a single linear alternator similar to that described in FIGS. 1A-1D, 2, 3A, and 3B. Here too, four sets of equally spaced shuttle magnets in each cylinder are arranged head-to-toe and separated by spacers and insulators. As in FIG. 2, the shuttle magnets are mounted as an assembly on a rod independently driven by the crankshaft such that each of five rods in different phases can correspondingly move back and forth inside four matching sets of equally spaced pickup coils. Alternating currents from each of the twenty total pickup coils are individually rectified by full-wave bridges (fwb), then smoothed by a filter capacitor 430 for a raw DC output. Solid-state inverters can be connected at the output 412 to produce utility grade AC power from a summation point 432. A voltage ripple 434 on summation point 432 will be very modest and should be easily controlled by filter capacitor 430.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A linear electrical generator, comprising:
a hollow cylinder configured with linear bearings at opposite ends, wherein the bearings are aligned to be collinear with each other to float a single reciprocating shaft;
a single file of annular-ring pickup coils coaxially disposed and supported in a row within the cylinder, wherein the annular-ring pickup coils are equally spaced and parallel to one another;
a single reciprocating shaft suspended inside the cylinder at opposite ends by the linear bearings that align and position the shaft through the centers of the single file of annular-ring pickup coils;
a head-to-toe row of permanent magnets collinearly arranged in totem-pole fashion on a middle length of the reciprocating shaft, wherein the interspacing of each group of neodymium permanent magnets is equal and matches the interspacings of the annular-ring pickup coils; and
a linking rod for receiving a mechanical input power and a mechanism for stroking the single reciprocating shaft and each permanent magnet through a corresponding annular-ring pickup coil;
wherein said mechanical input power can be converted to an electrical output power available from each of the annular-ring pickup coils.

2. The linear electrical generator of claim 1, wherein:
the hollow cylinder is constructed of aluminum.

3. The linear electrical generator of claim 1, wherein:
the linear bearings are substantially comprised of polyoxymethylene (POM).

4. The linear electrical generator of claim 1, wherein:
the reciprocating shaft principally comprises 316-type stainless steel and produces a friction free interface with the linear bearings.

5. The linear electrical generator of claim 1, wherein:
the permanent magnets are puck-shaped and principally comprised of neodymium alloy,

6. The linear electrical generator of claim 1, wherein:
the electrical power output taken from each of the annular-ring pickup coils is independently full-wave rectified, summed together, filtered, and regulated to charge a battery.

7. A five-radial linear alternator, comprising:
a radial arrangement of five cylinders around a common crankshaft, and configured such that mechanical input power can be applied to the crankshaft for conversion to electrical output power;
wherein, each of the five cylinders is in itself a single linear alternator, comprising:
a hollow cylinder configured with linear bearings at opposite ends, in which the bearings are aligned to be collinear with each other to float a single reciprocating shaft;
a single file of annular-ring pickup coils coaxially disposed and supported in a row within each cylinder, wherein the annular-ring pickup coils are equally spaced and physically parallel to one another;
a single reciprocating shaft suspended inside each cylinder at opposite ends by the linear bearings that align and position each corresponding shaft through the centers of each respective single file of annular-ring pickup coils;
a head-to-toe row of permanent magnets collinearly arranged in totem-pole fashion on a middle length of each reciprocating shaft, wherein the interspacing of each group of neodymium permanent magnets is equal and matches the interspacings of the corresponding annular-ring pickup coils; and
a linking rod for independently receiving a mechanical input power and a mechanism for stroking each single reciprocating shaft and each permanent magnet through its corresponding annular-ring pickup coils;
wherein said mechanical input power is convertible to an electrical output power available in parallel from each of the annular-ring pickup coils.

8. The five-radial linear alternator of claim 7, wherein, alternating currents from each of the twenty total pickup coils are individually rectified, filtered, and regulated to charge banks of batteries or ultra-capacitors. Solid-state inverters can be connected to the batteries or ultra-capacitors to produce utility grade AC power, or DC power outputs can be tapped directly.

9. The five-radial linear alternator of claim 7, wherein,
the hollow cylinders are each constructed of aluminum;
the linear bearings are substantially comprised of polyoxymethylene (POM);
each reciprocating shaft principally comprises 316-type stainless steel and produces a friction free interface with the linear bearings;
the permanent magnets are puck-shaped and principally comprised of neodymium alloy; and
the electrical power output taken from each of the annular-ring pickup coils is independently full-wave rectified, summed together, and ripple filtered.

10. A method for generating electrical power from a mechanical power input, comprising:
arranging five linear alternators in an equal radial arrangement of 72-degrees around a single mechanical crankshaft, and each having a shaft able to reciprocate on linear bearings;
linking each and all of the shafts of the five linear alternators to the single mechanical crankshaft to receive a reciprocating stroke that will be equally separated in phase by 72-degrees amongst one another to total 360-degrees of angle;
mounting permanent magnets of equal number on each of the respective shafts such that an application of mechanical input power will cause them all to correspondingly reciprocate;
positioning annular-ring pickup coils at fixed positions in which a corresponding magnet can shuttle back and forth during operation;
independently rectifying the AC output of each annular-ring pickup coil; and
summing the DC outputs into a single summation point following the step of independently rectifying the AC output of each annular-ring pickup coil;
wherein, an electrical power output is made available for use from said summation point.
